(19) United States
(12) Patent Application Publication
(10) Pub. No.: US 2011/0163646 A1
(43) Pub. Date: Jul. 7, 2011

(54) SURFACE STRUCTURE OF METAL CABINET AND SURFACE PROCESSING METHOD FOR PREPARING THE SAME

(76) Inventor: Chia Ming LIU, Yunlin County (TW)

(21) Appl. No.: 12/651,696

(22) Filed: Jan. 4, 2010

(51) Int. Cl. A47B 88/04; B23P 11/00; B05D 1/02

(52) U.S. Cl. 312/330.1; 29/458

(57) ABSTRACT

A surface structure of a metal cabinet and a surface processing method for preparing the same are provided. Before assembling the metal cabinet, areas which will be more frequently touched or worn and torn are defined as processing areas on the metal cabinet. The processing areas are then conducted with a plurality of pretreatment processes. Then, a colored paint layer is formed on the processing areas, and then a clear lacquer layer is formed on the colored paint layer. Preferably, the clear baking finish layer has a thickness within a range from 40 μm to 65 μm. In such a way, the surface structure obtained according to the present invention is adapted for preventing corrosion, improving the color performance, and providing surface protection and maintenance.

### BACKGROUND OF THE INVENTION

1. Field of the Invention

The present invention relates generally to a surface structure of a metal cabinet and a surface processing method for preparing the same, and more particularly, to a surface structure of a certain colored surface area of a metal cabinet, and a surface processing method for preparing the same.

2. The Prior Arts

There are many kinds of metal cabinets being sold in the market, such as tool cabinets, cupboards, or file cabinets, or even grillers or ovens. Generally, metal cabinets are structurally stronger than other kinds, and are usually capable of supporting heavier loads, and they usually also have better heat resistance and better corrosion resistance. In addition, metal materials are recyclable, and therefore metal cabinets can be more conveniently recycled for reusing than cabinets containing plastic. Accordingly, many cabinets designed for holding heavy loads are often made of metal materials.

For example, a typical metal cabinet is shown in FIG. 1. Referring to FIG. 1, a metal cabinet includes a body 1 and drawers 2. In many circumstances, a certain percentage of structure of a metal cabinet is desired to be conducted with a color spray painting process. For example, as shown in FIG. 1, the body 1 of the metal cabinet includes side boards 11, a top board 12, and front boards 21 of drawers 2. The side boards 11 and the top board 12 usually occupy a large percentage of the overall surface area of the metal cabinet, and they are often processed for displaying ornamental colors for satisfying the customers.

In general, according to a conventional surface processing method, a layer of colored paint is often sprayed on the metal surface of the metal cabinet or a primer layer coated on the surface of the metal cabinet. Such a primer layer is usually provided when the colored paint is a light color for solidly presenting the light color with a desired effect.

FIG. 2 is a schematic diagram illustrating a cross-sectional view of a part of metal surface M of the conventional metal cabinet. No matter the colored paint sprayed on the metal surface M is a light color or a dark color, only a colored paint layer C having a certain thickness is formed on the metal surface M. Such a colored paint layer C is exposed in direct contact with environmental factors, such as humidity, physical touch, acid, or thermal resistance. These environmental factors may oxidize, degrade, or wear and tear the colored paint layer C, so that the colored paint layer C may be damaged after being used for a certain time. When the colored paint layer C gets in physical contact with a surface area of a large object, and particularly when the object has a superior surface hardness, a certain degree of such physical contact may cause a scratching damage in the metal surface M as shown in FIG. 2. In such a way, a scratch defect d is generated and apparently presents in the colored paint layer C. Such a scratch defect d usually destroys the protection provided by the colored paint layer C to the metal surface M, thus accelerating the corrosion to the certain position of the scratch defect d. In addition, the appearance of the metal cabinet may be looked untidy because of the scratched defect d.

Specifically, when a metal cabinet is often used for conserving objects, the metal cabinet must be frequently touched by the objects and users' hands. Therefore, unavoidably, there must be some certain surface areas of the metal cabinet more frequently touched by the objects and users' hands, so that these certain surface areas are usually more seriously worn and torn than elsewhere. Such certain surface areas for example include surface areas of front boards 21 of the drawers 2, or top surface areas of the top board 12 available for putting objects thereon.

In general, when spray painting the conventional metal cabinets, the spray painting process is often entirely conducted over the whole metal cabinet. However, even when a metal cabinet is repetitively spray painted for several times, the foregoing problems cannot be completely prevented.

### SUMMARY OF THE INVENTION

A primary objective of the present invention is directed to provide a solution for solving the aforementioned problems.

For achieving the objective, the present invention provides a surface structure of a metal cabinet and a surface processing method for preparing the same. According to the present invention, areas which will be more frequently touched or worn and torn are defined as processing areas on the metal cabinet. The processing areas are then conducted with a plurality of pretreatment processes, such as a degreasing bath process, a phosphatizing process, a washing process, and a drying process. Then, a thick layer of colored paint is formed on the processing areas by spraying painting thereon. The thick layer of colored paint is then baked, and then a clear lacquer layer is formed on the thick layer of colored paint by spray painting the clear lacquer onto the thick layer. When the clear lacquer layer achieves a certain thickness, the clear lacquer layer is baked to form a clear baking finish layer on the thick layer. In such a way, the surface structure obtained according to the present invention is adapted for preventing corrosion, improving the color performance, and providing surface protection and maintenance. Further, according to a preferred embodiment of the present invention, the colored paint layer has a thickness within a range of 20 μm±5 μm, and the clear baking finish layer has a thickness within a range from 40 μm to 65 μm.

### BRIEF DESCRIPTION OF THE DRAWINGS

The present invention will be apparent to those skilled in the art by reading the following detailed description of preferred embodiments thereof, with reference to the attached drawings, in which:

FIG. 1 is a schematic diagram illustrating a typical metal cabinet;

FIG. 2 is a cross-sectional view of a part of metal surface M of the conventional metal cabinet;

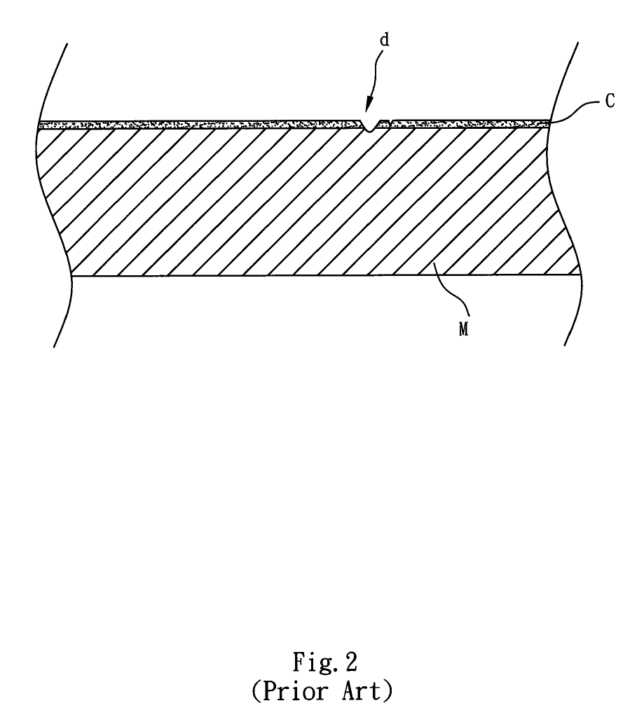

FIG. 3 is a partial cross-sectional view of a metal surface according to a first embodiment of the present invention;

FIG. 4 is a partial cross-sectional view of a metal surface according to a second embodiment of the present invention;

FIG. 5 is a partial cross-sectional view of a metal surface according to an embodiment of the present invention; and

FIG. 6 is a flow chart illustrating a surface processing method for preparing a surface structure of a metal cabinet.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

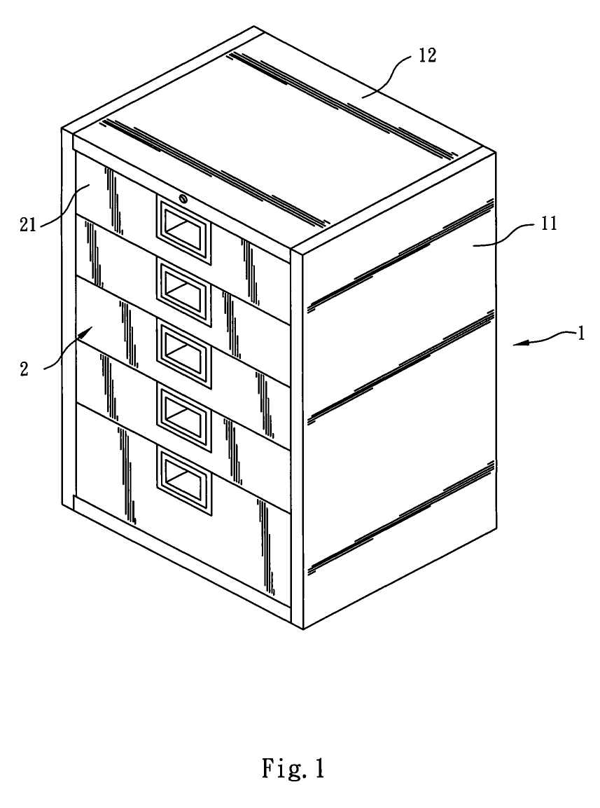

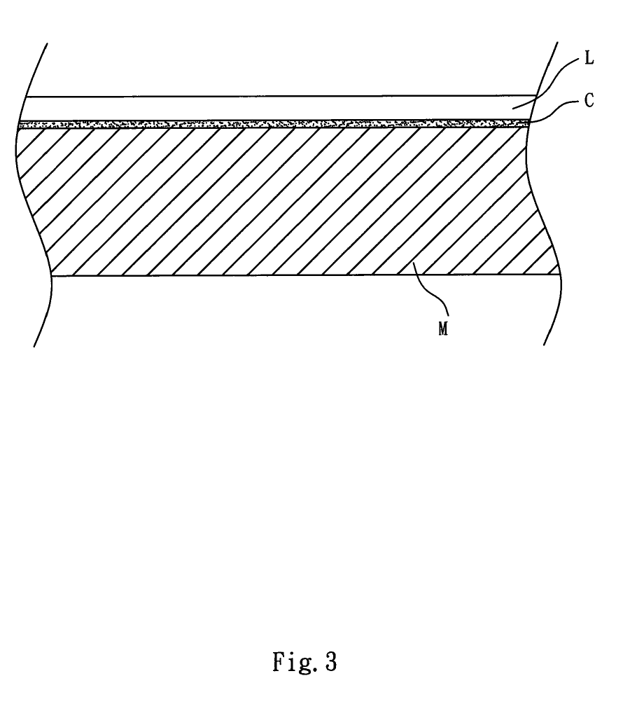

FIG. 3 is a partial cross-sectional view of a metal surface according to a first embodiment of the present invention. Referring to FIG. 3, the present invention provides a surface structure of a metal cabinet and a surface processing method for preparing the same. It should be noted that the surface structure of the present invention can be configured at any kinds of metal cabinet. For illustration purpose, the metal surface M of the metal cabinet as shown in FIG. 1 is used as shown in FIG. 3 for configuring the surface structure of the present invention. The metal cabinet of the present invention is similar to that shown in FIG. 1, and includes a plurality of metal surfaces M and one or more drawers. In accordance with the first embodiment of the present invention, areas of the metal surfaces M which are likely to be more frequently touched or worn and torn are defined as processing areas on the metal cabinet. After a cutting and forming process, the processing areas are conducted with a plurality of pretreatment processes. The pretreatment processes for example include a degreasing bath process, a phosphatizing process, a washing process, and a drying process. The pretreatment processes are conducted for allowing the processing areas to be well bonded with the subsequent colored paint layer C. Upon the completion of the pretreatment process, the processing areas are conducted with a spray painting process for forming a colored paint layer C thereon. Preferably, the colored paint layer C has a thickness controlled within a range of 20 μm±5 μm. The thickness of the colored paint layer C is controlled in accordance with the color shade of the colored paint layer C, so as to prevent any color variation caused to the large area of spray painting.

Then, the colored paint layer C is baked and cured. After baking and curing the colored paint layer C, a spray painting process is conducted for spray painting a clear lacquer layer onto the colored paint layer C. The clear lacquer layer is adapted for protecting the colored paint layer C in the processing areas.

The clear lacquer layer is then baked to form a clear baking finish layer L on the colored paint layer C. Preferably, the clear baking finish layer L has a thickness controlled within a range of 40 μm to 65 μm. According to the present invention, the thickness of the clear baking finish layer L should be neither thicker nor thinner than this range. The clear baking finish layer having a smaller thickness than this range provides insufficient resistance against abrasion and scratching. Further, if the clear baking finish layer L is too thick, e.g., the thickness is greater than the range, after the spray painting process is completed, the outside of the clear lacquer layer would be likely to be drier than the inside of the clear lacquer layer. Further, when the clear lacquer layer is too thick, the paint may flow, or otherwise when the clear lacquer layer is too thin, an orange peel appearance may occur.

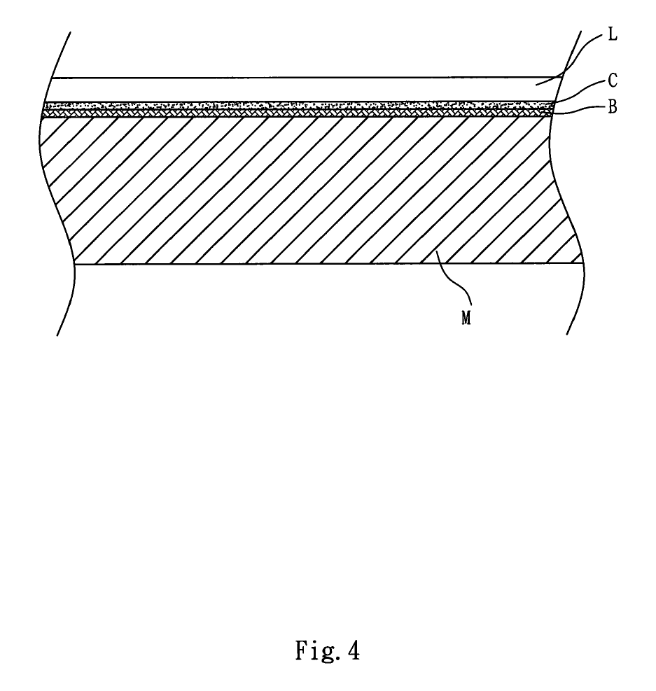

FIG. 4 is a partial cross-sectional view of a metal surface according to a second embodiment of the present invention. Referring to FIG. 4, when the color of the colored paint layer C to be provided onto the metal surfaces M is a light color, e.g., white or yellowish, one or more layers of primer layers B are often necessary to be provided prior to forming the colored paint layer C for optimally presenting the color of the colored paint layer C.

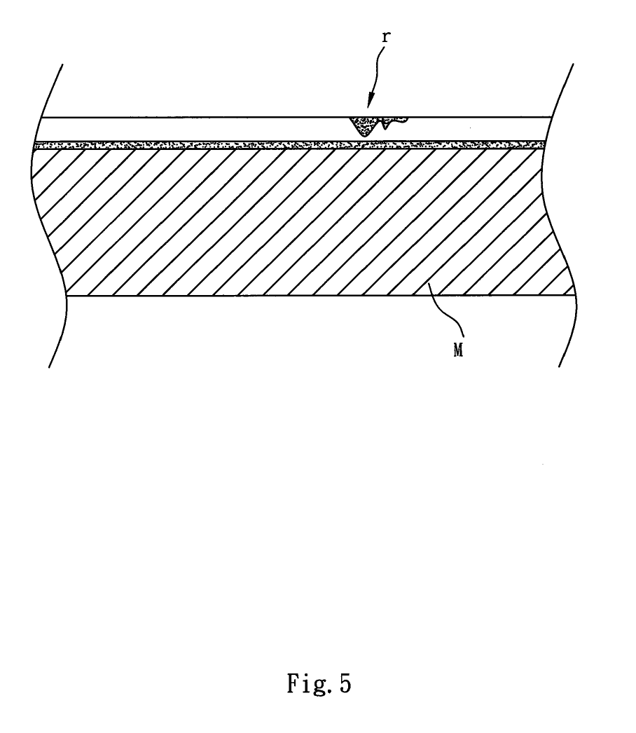

FIG. 5 is a partial cross-sectional view of a metal surface according to an embodiment of the present invention. After conducting the surface processing method to the metal cabinet according to the present invention, the surface structure of the metal cabinet includes a clear baking finish layer L having a certain thickness. The clear baking finish layer L protects the colored paint layer C from being eroded, scratched. As shown in FIG. 5, when a scratch defect occurs at a position r located in the processing areas, if the scratch defect is not as serious as damaging the metal surface M, the scratch defect can be refurbished by wax polishing thereby for maintaining the metal surfaces M in a good condition. Accordingly, the present invention is adapted for anticorrosion, preventing scratch defects, and recovering the metal surfaces by providing a clear baking finish layer.

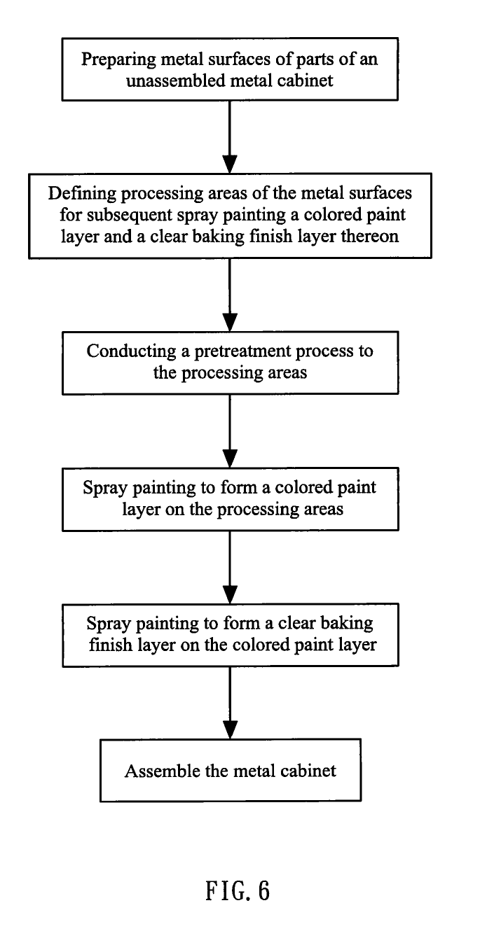

FIG. 6 is a flow chart illustrating a surface processing method for preparing a surface structure of a metal cabinet. Referring to FIG. 6, the present invention provides a surface processing method for preparing a surface structure of the metal cabinet. The surface processing method includes the following steps. At first, preparing parts to be assembled into a metal cabinet having metal surfaces. Then, areas of the metal surfaces which are likely to be more frequently touched or worn and torn are defined as processing areas on the metal cabinet. Then, a plurality of pretreatment processes are conducted on the processing areas. Then, a colored paint layer is formed on the metal surfaces by spraying painting the colored paint thereon. Then, a clear baking finish layer is formed on the colored paint layer by spraying painting a clear lacquer layer on the colored paint layer and baking and curing the same thereafter. Then, the parts are then assembled to obtain a metal cabinet having the surface structure according to the present invention. Preferably, the colored paint layer has a thickness controlled within a range of 20 μm±5 μm, and the clear baking finish layer L has a thickness controlled within a range of 40 μm to 65 μm.

According to the present invention, the processing areas are correspondingly defined in accordance with the areas of the metal surfaces which are likely to be more frequently touched or worn and torn. Therefore, the rest areas which are not likely to be frequently touched or worn and torn are not required to be conducted with the foregoing processing method. Accordingly, the present invention is not only adapted for anticorrosion, preventing scratch defects, and recovering the metal surfaces by providing a clear baking finish layer, but also adapted for saving the production cost.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A surface processing method for a metal cabinet, comprising:
defining an area of a metal surface of an unassembled metal cabinet as a processing area for further processing;
conducting a pretreatment process on the processing area;
spray painting to form at least one colored paint layer on the processing area;
spray painting to form a clear lacquer layer onto the colored paint layer on the processing area, wherein the clear lacquer layer has a thickness within a range from 40 μm to 65 μm; and
assembling the metal cabinet.

2. The surface processing method according to claim 1, wherein the pretreatment process comprises a degreasing bath process, a phosphatizing process, a washing process, and a drying process.

3. The surface processing method according to claim 1, wherein the colored paint layer has a thickness within a range of 20 μm±5 μm.

4. The surface processing method according to claim 1, wherein after the colored paint layer is formed on the metal surface and before the clear lacquer layer is formed on the colored paint layer, the colored paint layer is baked and cured on the metal surface.

5. The surface processing method according to claim 1, wherein after the clear lacquer layer is formed on the colored paint layer, the clear lacquer layer is baked and cured to form a clear baking finish layer having a thickness within a range from 40 μm to 65 μm.

6. A surface structure of a metal cabinet, comprising:
a body, comprising a plurality of metal surfaces, wherein a part of the metal surfaces are sequentially provided with a colored paint layer and a clear baking finish layer thereon; and
at least one drawer, assembled in the metal cabinet, the drawer comprising a front board, wherein the front board has an outwardly exposed metal surface sequentially covered with a colored paint layer and a clear baking finish layer thereon,
wherein the clear baking finish layer provided on the metal surfaces of the body and the clear baking finish layer covering the metal surface of the front board of the drawer have a thickness within a range from 40 μm to 65 μm.

7. The surface structure according to claim 6, wherein the colored paint layer provided on the metal surfaces of the body and the colored paint layer covering the metal surface of the front board of the drawer have a thickness within a range of 20 μm±5 μm.
